(19) United States
(12) Patent Application Publication
(10) Pub. No.: US 2016/0344179 A1
(43) Pub. Date: Nov. 24, 2016

(54) INRUSH CURRENT PROTECTION CIRCUIT

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: SHENG-CHUNG HUANG, New Taipei (TW); LEI YANG, Wuhan (CN); CHAO LV, Wuhan (CN)

(21) Appl. No.: 14/750,530

(22) Filed: Jun. 25, 2015

(30) Foreign Application Priority Data
May 22, 2015 (CN) 201510264871.9

(51) Int. Cl. H02H 3/087

(52) U.S. Cl. CPC H02H 3/087

(57) ABSTRACT

An inrush current protection circuit includes a DC/DC convertor, a control circuit, and a comparison circuit. The control circuit includes a field effect transistor (FET) and a first capacitor coupled to the FET. The comparison circuit and the FET are coupled to the DC/DC convertor. The comparison circuit is configured to output a control signal after the DC/DC convertor soft starts. The first capacitor is configured to be charged after receiving the control signal. The FET is configured to be switched on after a first period of time after the first capacitor is charged. The first capacitor is also configured to be discharged after being charged. The FET is also configured to be switched off after a second period of time after the first capacitor is discharged. The DC/DC convertor is also configured to be switched on after a third period of time after the FET is switched on.

### FIELD

The subject matter herein generally relates to protection circuits.

### BACKGROUND

An inrush current protection circuit may be used to protect electronic devices when inrush current is present.

### BRIEF DESCRIPTION OF THE DRAWINGS

Implementations of the present technology will now be described, by way of example only, with reference to the attached figures.

FIG. 1 is a block diagram of one embodiment of an inrush current protection circuit.

FIG. 2 is a circuit diagram of the inrush current protection circuit of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

The present disclosure is described in relation to an inrush current protection circuit to protect electronic devices when inrush current is present.

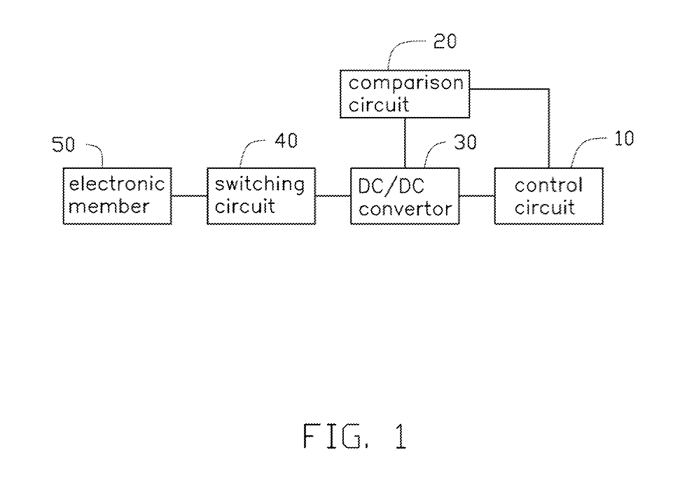

FIG. 1 illustrates an embodiment of an inrush current protection circuit. The inrush current protection circuit comprises a control circuit 10, a comparison circuit 20, and a DC/DC convertor 30. The control circuit 10 and the comparison circuit 20 are coupled to the DC/DC convertor 30. The DC/DC convertor 30 is configured to couple to a switching circuit 40. The switching circuit 40 is configured to couple to one or more electronic members 50. In one embodiment, a type of the DC/DC convertor 30 is MAX668/MAX669.

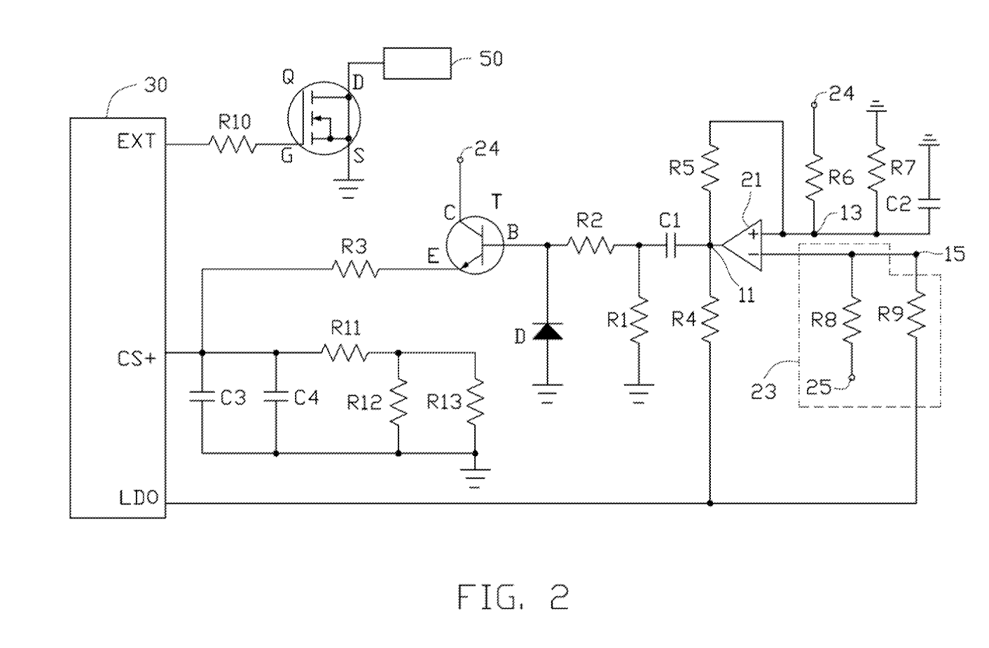

FIG. 2 illustrates that the control circuit 10 comprises a triode T, a diode D, a first capacitor C1, a first resistor R1, a second resistor R2, and a third resistor R3. In one embodiment, the triode T is an npn triode.

The DC/DC convertor 30 is configured to generate inrush current when soft starting. The comparison circuit 20 is configured to output a control signal after the DC/DC convertor 30 soft starts. The first capacitor C1 is configured to be charged after receiving the control signal. The triode T is configured to be switched on in a first delayed time after the first capacitor C1 is charged. The DC/DC convertor 30 is configured to be in a braking mode after the triode T is switched on. The first capacitor C1 is further configured to be discharged after being charged. The triode T is further configured to be switched off after a second period time after the first capacitor C1 is discharged. The DC/DC convertor 30 is further configured to be switched on after a third period time after the triode T is switched off, thereby decreasing impact strength from the inrush current, thus protecting the electronic member 50. In one embodiment, the control signal is a high level signal.

The comparison circuit 20 comprises a comparator 21, a reference circuit 23, a power supply 24, a second capacitor C2, a fourth resistor R4, a fifth resistor R5, a sixth resistor R6, and a seventh resistor R7. In one embodiment, the power supply 24 is configured to provide a 12V first voltage.

The reference circuit 23 comprises a reference power supply 25, an eighth resistor R8, and a ninth resistor R9. In one embodiment, the reference power supply 25 is configured to provide a 5V second voltage.

The switching circuit 40 comprises a field effect transistor (FET) Q and a tenth resistor R10. The FET Q comprises a gate terminal G, a source terminal S, and a drain terminal D.

The DC/DC convertor 30 comprises a gate exit terminal EXT, a current sensor positive terminal CS+, and a chip adjustor output terminal LDO.

The gate exit terminal EXT of the DC/DC convertor 30 is coupled to the gate terminal G of the FET via the tenth resistor R10. The current sensor positive terminal CS+ of the DC/DC convertor 30 is coupled to one end of an eleventh resistor R11. The other end of the eleventh resistor R11 is coupled to the source terminal S of the FET Q and is grounded via a twelfth resistor R12 and a thirteenth resistor R13. The current sensor positive terminal CS+of the DC/DC convertor 30 is grounded via a third capacitor C3 and is grounded via a fourth capacitor C4. The source terminal S of the FET Q is grounded. The drain terminal D of the FET Q is coupled to the electronic member 50.

An emitter of the triode T is coupled to one end of the third resistor R3. The other end of the third resistor R3 is coupled to the current sensor positive terminal CS+ of the DC/DC convertor 30. A collector of the triode T is coupled to the power supply 24. A base of the triode T is coupled to a cathode of the diode D and one end of the second resistor R2. The other end of the second resistor R2 is coupled to one end of the first resistor R1 and one end of the first capacitor C1. The other end of the first resistor R1 is grounded. The other end of the first capacitor C1 is coupled to a first node 11.

One end of the fourth resistor R4, one end of the fifth resistor R5, and an output terminal of the comparator 21 are coupled to the first node 11. The other end of the fifth resistor R5, a positive terminal of the comparator 21, one end of the sixth resistor R6, one end of the seventh resistor R7, and one end of the second capacitor C2 are coupled to a second node 13. The other end of the sixth resistor R6 is coupled to the power supply 24. The other end of the seventh resistor R7 is grounded. The other end of the second capacitor C2 is grounded. A reverse input terminal of the comparator 21 is coupled to a third node 15. The third node 15 is coupled to one end of the eighth resistor R8. The other end of the eighth resistor R8 is coupled to the reference power supply 25. The third node 15 is coupled to one end of the ninth resistor R9. The other end of the ninth resistor R9 is coupled to the chip adjustor output terminal LDO of the DC/DC convertor 30.

A principle of the inrush current protection circuit is as follows. After the DC/DC convertor 30 soft starts, the comparator 21 outputs a control signal, thereby enabling the first capacitor C1 to be charged. The first capacitor C1 is charged in a first time. The triode T is switched on in a first period time, thereby enabling the DC/DC convertor 30 to be in a braking mode. The first capacitor C1 is discharged after being charged. After the first capacitor C1 is discharged a second time, the triode T is switched off at a second period time, thereby enabling the DC/DC convertor 30 to be switched on at a third period time, thus decreasing impact strength from the inrush current and protecting the electronic member 50.

In one embodiment, a resistance value of the first resistor R1 is 1 MΩ, a resistance value of the second resistor R2 is 12 kilo-ohm (KΩ), a resistance value of the third resistor R3 is 3.9 KΩ, a resistance value of the fourth resistor R4 is 12 KΩ, a resistance value of the fifth resistor R5 is 120 KΩ, a resistance value of the sixth resistor R6 is 22 KΩ, a resistance value of the seventh resistor R7 is 22 KΩ, a capacitance value of the first capacitor C1 is 220 nF, and a capacitance value of the second capacitor C2 is 10 nF.

It is to be understood that even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure to the full extent indicated by the broad general meaning of the terms in which the appended claims are expressed.

What is claimed is:

1. An inrush current protection circuit comprising:
a DC/DC convertor,
a control circuit having:
a field effect transistor (FET) coupled to the DC/DC converter, and
a first capacitor coupled to the FET; and
a comparison circuit coupled to the DC/DC convertor;
wherein the comparison circuit is configured to output a control signal after the DC/DC convertor soft starts;
wherein the first capacitor is configured to:
be charged after receiving the control signal;
be discharged after being charged;
wherein the FET is configured to be switched off after a first period of time after the first capacitor is discharged; and
wherein the DC/DC convertor is also configured to be switched on after a second period of time after the FET is switched on.

2. The inrush current protection circuit of claim 1, wherein the comparison circuit comprises a comparator, the comparator is coupled to the first capacitor, and the comparator is configured to output the control signal after the DC/DC convertor starts.

3. The inrush current protection circuit of claim 2, wherein the comparison circuit further comprises a power supply, the power supply is coupled to the comparator, and the power supply is configured to provide a first voltage.

4. The inrush current protection circuit of claim 3, wherein the comparison circuit further comprises a reference circuit, the reference circuit is coupled to the comparator, the reference circuit is configured to provide a second voltage, and the comparator is configured to compare the first voltage with the second voltage.

5. The inrush current protection circuit of claim 4, wherein the comparison circuit further comprises a first resistor and a second resistor, the power supply is coupled to one end of the first resistor, the other end of the first resistor is coupled to a positive terminal of the comparator and one end of the second resistor, and the other end of the second resistor is grounded.

6. The inrush current protection circuit of claim 5, wherein the comparison circuit further comprises a third resistor, the comparator positive terminal of the is coupled to one end of the third resistor, the other end of the third resistor is coupled to an output terminal of the comparator, and the output terminal of the comparator is also coupled to one end of the first capacitor.

7. The inrush current protection circuit of claim 5, wherein the reference circuit comprises a third resistor and a reference power supply, the reference power supply is coupled to one end of the third resistor, and the other end of the third resistor is coupled to a reverse terminal of the comparator.

8. The inrush current protection circuit of claim 7, wherein the reference circuit further comprises a fourth resistor, the reverse terminal of the comparator is coupled to one end of the fourth resistor, and the other end of the fourth resistor is coupled to the DC/DC convertor.

9. The inrush current protection circuit of claim 1, wherein the control circuit further comprises a resistor, one end of the first capacitor is coupled to the comparison circuit, and the other end of the first capacitor is grounded via the resistor.

10. The inrush current protection circuit of claim 9, wherein a base of the triode is grounded via the first resistor, an emitter of the triode is coupled to the power supply, and a collector of the triode is coupled to a power supply.

11. An inrush current protection circuit comprising:
a DC/DC convertor,
a control circuit having:
a field effect transistor (FET) coupled to the DC/DC convertor, and
a first capacitor coupled to the FET; and
a comparison circuit coupled to the DC/DC convertor;
wherein the comparison circuit is configured to output a control signal after the DC/DC convertor soft starts;
wherein the first capacitor is configured to be charged after receiving the control signal;
wherein the FET is configured to be switched on after a first period of time after the first capacitor is charged;
wherein the DC/DC convertor is configured to be in a braking mode after the FET is switched on;
wherein the first capacitor is also configured to be discharged after be charged;
wherein the FET is also configured to be switched off after a second period of time after the first capacitor is discharged; and
wherein the DC/DC convertor is also configured to be switched on after a third period of time after the FET is switched on.

12. The inrush current protection circuit of claim 11, wherein the comparison circuit comprises a comparator, the comparator is coupled to the first capacitor, and the comparator is configured to output the control signal after the DC/DC convertor starts.

13. The inrush current protection circuit of claim 12, wherein the comparison circuit further comprises a power supply and a reference circuit, the power supply and the reference circuit are coupled to the comparator, the power supply is configured to provide a first voltage, the reference circuit is configured to provide a second voltage, and the comparator is configured to compare the first voltage with the second voltage.

14. The inrush current protection circuit of claim 13, wherein the comparison circuit further comprises a first resistor and a second resistor, the power supply is coupled to one end of the first resistor, the other end of the first resistor is coupled to a positive terminal of the comparator and one end of the second resistor, and the other end of the second resistor is grounded.

15. The inrush current protection circuit of claim 14, wherein the comparison circuit further comprises a third resistor, the comparator positive terminal of the is coupled to one end of the third resistor, the other end of the third resistor is coupled to an output terminal of the comparator, and the output terminal of the comparator is also coupled to one end of the first capacitor.

16. The inrush current protection circuit of claim 14, wherein the reference circuit comprises a third resistor and a reference power supply, the reference power supply is coupled to one end of the third resistor, and the other end of the third resistor is coupled to a reverse terminal of the comparator.

17. The inrush current protection circuit of claim 16, wherein the reference circuit further comprises a fourth resistor, the reverse terminal of the comparator is coupled to one end of the fourth resistor, and the other end of the fourth resistor is coupled to the DC/DC convertor.

18. The inrush current protection circuit of claim 13, wherein the first voltage is greater than the second voltage.

19. The inrush current protection circuit of claim 11, wherein the control circuit further comprises a resistor, one end of the first capacitor is coupled to the comparison circuit, and the other end of the first capacitor is grounded via the resistor.

20. The inrush current protection circuit of claim 11, wherein the control signal is a high level signal.
